(19) United States
(12) Patent Application Publication
(10) Pub. No.: US 2025/0293561 A1
(43) Pub. Date: Sep. 18, 2025

(54) STATOR AND METHOD FOR PRODUCING STATOR

(71) Applicants: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(72) Inventors: Shintaro MORINO, Osaka-Shi, Osaka (JP); Kanzo ISHIHARA, Osaka-Shi, Osaka (JP)

(73) Assignees: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(21) Appl. No.: 18/859,310

(22) PCT Filed: Apr. 5, 2023
(86) PCT No.: PCT/JP2023/014126

§ 371 Date: Oct. 23, 2024

(30) Foreign Application Priority Data
Apr. 26, 2022 (JP) 2022-072388

(51) Int. Cl. H02K 3/12; H02K 1/16; H02K 15/02; H02K 15/085

(52) U.S. Cl. CPC H02K 3/12; H02K 1/16; H02K 15/02; H02K 15/085

(57) ABSTRACT

A coil has a first coil portion that is at least partially located within a slot, and a second coil portion having a first end press-fitted into the first coil portion. Insulating resin has a continuous filling portion that continuously fills a space between an inner wall of the slots and the first coil portion in a central part of the slots with respect to the axial direction. A first positioning component is located on a first side in an axial direction relative to the continuous filling portion, and positions the first coil portion while being at least partially sandwiched between the inner walls of the slot and the first coil portion in a circumferential direction of the stator core. The first positioning component covers a gap between the first coil portion and the second coil portion that are press-fitted into each other, in the circumferential direction.

### CROSS-REFERENCE TO RELATED APPLICATIONS

This application is the U.S. national stage of PCT/JP2023/014126 filed on Apr. 5, 2023, which claims priority of Japanese Patent Application No. JP 2022-072388 filed on Apr. 26, 2022, the contents of which are incorporated herein.

### TECHNICAL FIELD

The present disclosure relates to a stator and a method for producing a stator.

### BACKGROUND

JP 2013-62911A, JP 2020-33433A and FIG. 3D of JP 2021-191051A discloses stators. These stators each have a stator core to which a coil is fixed via insulating paper.

It is desired to improve heat dissipation of the above stators.

The present disclosure aims to provide a technology capable of improving heat dissipation of a coil.

### SUMMARY

A stator of the present disclosure includes: a stator core having a ring shape; a coil; insulating resin; and a positioning component, wherein the stator core has a plurality of slots arranged in a ring shape and extending through the stator core in an axial direction, the coil has: a first coil portion that is at least partially located within the slots; and a second coil portion having a first end press-fitted into a first end of the first coil portion, the insulating resin has a continuous filling portion continuously filling a space between an inner wall of the slots and the first coil portion in a central part of the slots with respect to the axial direction, the positioning component is located on a first side in the axial direction relative to the continuous filling portion, and positions the first coil portion while being at least partially sandwiched between the inner wall of the slots and the first coil portion in a circumferential direction of the stator core, and the positioning component covers a gap between the first coil portion and the second coil portion that are press-fitted into each other, in the circumferential direction.

A method for producing a stator is a method for producing a stator including a ring-shaped stator core and a coil, the stator core having a plurality of slots arranged in a ring shape and extending through the stator core in an axial direction, the coil having a first coil segment and second coil segment, and the method includes: a disposing step of disposing a jig on a first side in the axial direction of the slots; a positioning step of positioning the first coil segment using the jig; a press-fitting step of press-fitting a first end of the second coil segment into a first end of the first coil segment positioned in the positioning step; and a filling step of continuously filling a space between an inner wall of the slots and the first coil segment with insulating resin in a central part of the slots with respect to the axial direction, wherein in the press-fitting step, the first end of the second coil segment is press-fitted into the first end of the first coil segment with the first end of the first coil segment located in a range where the jig is present in the axial direction.

### Advantageous Effects

According to the present disclosure, the heat dissipation of a coil can be improved.

### BRIEF DESCRIPTION OF DRAWINGS

FIG. 1 is a perspective view of a stator core.

FIG. 2 is a cross-sectional view showing a part of a cross section of a stator taken in a direction orthogonal to an axial direction, as viewed from a second side in the axial direction.

FIG. 3 is a perspective view of a first positioning component as viewed from a first side in the axial direction.

FIG. 4 is a perspective view of the first positioning component as viewed from the second side in the axial direction.

FIG. 5 is a side view of first and second coil segments.

FIG. 6 is a cross-sectional view of the first coil segment positioned by the first and second positioning components.

FIG. 7 is a cross-sectional view of a slot filled with insulating resin.

FIG. 8 is a cross-sectional view of the first coil segment with the second coil segment press-fitted.

FIG. 9 is a diagram for illustrating a first other form of the first positioning component.

FIG. 10 is a diagram for illustrating a second other form of the first positioning component.

### DETAILED DESCRIPTION OF PREFERRED EMBODIMENTS

Embodiments of the present disclosure will be listed and illustrated below.

In a first aspect, a stator includes: a stator core having a ring shape; a coil; insulating resin; and a positioning component, wherein the stator core has a plurality of slots arranged in a ring shape and extending through the stator core in an axial direction, the coil has: a first coil portion that is at least partially located within the slots; and a second coil portion having a first end press-fitted into a first end of the first coil portion, the insulating resin has a continuous filling portion continuously filling a space between an inner wall of the slots and the first coil portion in a central part of the slots with respect to the axial direction, the positioning component is located on a first side in the axial direction relative to the continuous filling portion, and positions the first coil portion while being at least partially sandwiched between the inner wall of the slots and the first coil portion in a circumferential direction of the stator core, and the positioning component covers a gap between the first coil portion and the second coil portion that are press-fitted into each other, in the circumferential direction.

With this configuration, the insulating resin continuously fills the space between the inner walls of each slot and the first coil portion without insulating paper interposed. This can improve the heat dissipation of the coil compared to a configuration in which insulating paper is interposed. Furthermore, the positioning component positions the first coil portion with the insulating resin filling the space between the inner walls of the slot and the first coil portion. The position of the first coil portion is thus likely to be stable, and consequently, the heat dissipation performance of the first coil portion via the insulating resin is likely to be stable. Moreover, the positioning component covers the gap between the first and second coil portions in the circumferential direction, thus making it unlikely for a foreign object to enter the gap.

In a second aspect, the stator according to the first aspect, wherein the positioning component positions both the first coil portion and the second coil portion.

With this configuration, both the first and second coil portions are positioned by the positioning component positions, thus making the fitting therebetween unlikely to loosen.

In a third aspect, the stator according to the second aspect, wherein the positioning component positions the first coil portion and the second coil portion inside and outside the slots in the axial direction.

With this configuration, the first and second coil portions are positioned inside and outside the slot, and the positions of the first and second coil portions are thus likely to be stable.

In a fourth aspect, the stator according to any one of the first through the third aspects, wherein a recessed portion is provided at one of the first end of the first coil portion and the first end of the second coil portion, and a protruding portion is provided at another one of the first end of the first coil portion and the first end of the second coil portion, and the protruding portion is press-fitted into the recessed portion.

This configuration makes it easy to simplify the configuration in which the first and second coil portions are press-fitted to each other.

In a fifth aspect, the stator according to the fourth aspect, wherein the recessed portion is provided in the first coil portion, and the protruding portion is provided in the second coil portion.

The fitting faces of the recessed portion and the protruding portion are likely to generate heat when a current flows. However, with this configuration, heat generated in the fitting faces can easily be dissipated from the insulating resin since the fitting faces of the recessed portion and the protruding portion are located at positions relatively close to the insulating resin, compared to a configuration in which the recessed portion is provided in the second coil portion and the protruding portion is provided in the first coil portion.

In a sixth aspect, the stator according to the fourth or the fifth aspects, wherein the positioning component positions both the first coil portion and the second coil portion, and a length in the axial direction of a region where the positioning component positions the second coil portion is greater than a protruding dimension of the protruding portion and than a depth of the recessed portion.

This configuration enables the second coil portion to be portioned more accurately.

In a seventh aspect, a method for producing a stator including a ring-shaped stator core and a coil, the stator core having a plurality of slots arranged in a ring shape and extending through the stator core in an axial direction, the coil having a first coil segment and second coil segment, the method including: a disposing step of disposing a jig on a first side in the axial direction of the slots; a positioning step of positioning the first coil segment using the jig; a press-fitting step of press-fitting a first end of the second coil segment into a first end of the first coil segment positioned in the positioning step; and a filling step of continuously filling a space between an inner wall of the slots and the first coil segment with insulating resin in a central part of the slots with respect to the axial direction, wherein in the press-fitting step, the first end of the second coil segment is press-fitted into the first end of the first coil segment with the first end of the first coil segment located in a range where the jig is present in the axial direction.

With this configuration, insulating paper is not interposed between the inner walls of each slot and the first coil segment in the continuous filling portion. This allows heat of the first coil segment to be easily dissipated. Moreover, the first end of the second coil segment is press-fitted into the first end of the first coil segment with the first end of the first coil segment located in the range where the jig is present in the axial direction. This makes it unlikely that the position of the first coil segment shifts, and makes it easy to press-fit the second coil segment.

In an eighth aspect, the method for producing a stator according to the seventh aspect, wherein the jig has a pair of positioning faces that position the first coil segment and the second coil segment, and a pair of inclined faces that guide the second coil segment into a space between the two positioning faces, and in the disposing step, the jig is disposed such that the pair of inclined faces is located on the first side in the axial direction relative to the pair of positioning faces.

With this configuration, when the second coil segment is inserted between the two positioning faces, the inclined faces guide the second coil segment into the space between the two positioning faces even if the position of the second coil segment shifts slightly. Thus, this configuration allows the second coil segment to be easily passed between the two positioning faces from the first side in the axial direction.

In a ninth aspect, the method for producing a stator according to the seventh or the eighth aspects, wherein a recessed portion is provided at one of the first end of the first coil portion and the first end of the second coil portion, and a protruding portion is provided at another one of the first end of the first coil portion and the first end of the second coil portion, the protruding portion is press-fitted into the recessed portion, the jig has a pair of positioning faces that positions the first coil segment and the second coil segment, and in the positioning step, the first coil segment is positioned such that a length in the axial direction of a region where the second coil segment is positioned in the pair of positioning faces is greater than a protruding dimension of the protruding portion.

With this configuration, the second coil segment can be press-fitted into the first coil segment with the second coil segment being guided into the space between the two positioning faces. Thus, this configuration allows the second coil segment to be easily press-fitted into the first coil segment.

In a tenth aspect, the stator according to any one of the seventh through the ninth aspects, wherein in the filling step, the slots are filled with the insulating resin while blocking an opening of the slots on the first side in the axial direction using the jig.

With this configuration, the jig can easily prevent the insulating resin from leaking to the outside from the opening on the first side in the axial direction of each slot.

### First Embodiment

### Configuration of Stator 1

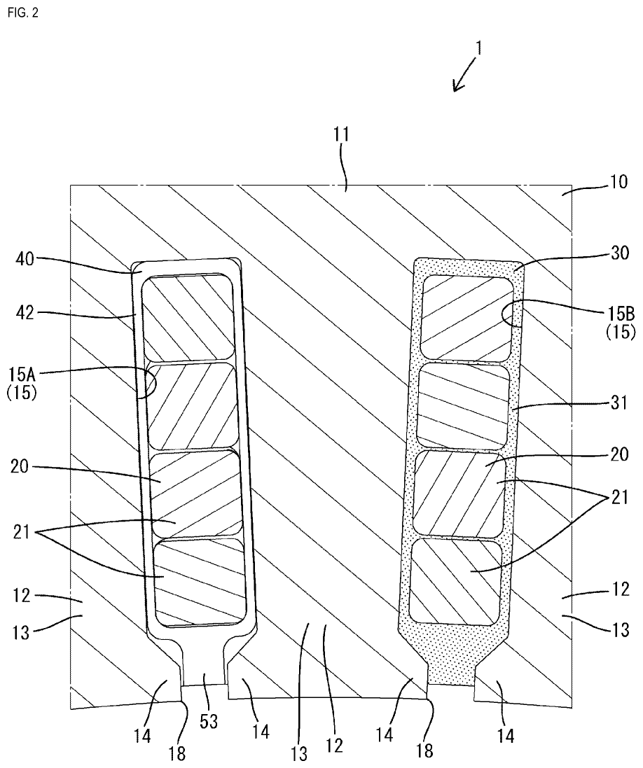

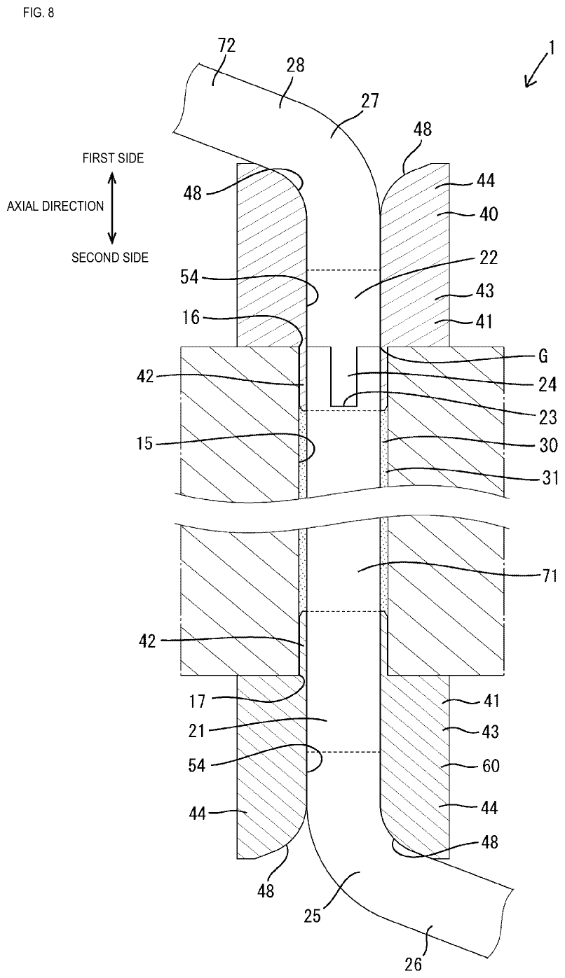

A stator 1 of the first embodiment is used as a component of a rotating electric machine (specifically, a motor). The stator 1 has a ring shape, or more specifically, a circular shape. The stator 1 includes a stator core 10, a coil 20, insulating resin 30, a first positioning component 40, and a second positioning component 60, as shown in FIGS. 2 and 8.

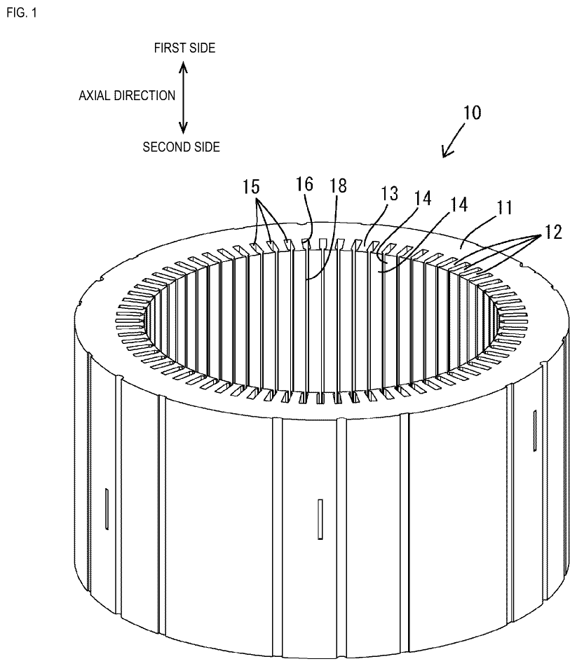

The stator core 10 has a ring shape, or more specifically, a circular shape, as shown in FIG. 1. Hereinafter, the radial direction of the stator core 10 is referred to as “radial direction”, the axial direction of the stator core 10 is referred to as “axial direction”, and the circumferential direction of the stator core 10 is referred to as “circumferential direction”.

The stator core 10 has a yoke portion 11 and tooth portions 12, as shown in FIGS. 1 and 2. The yoke portion 11 has a ring shape, or more specifically, a circular shape. A plurality of tooth portions 12 are arranged in a ring shape along the inner circumferential face of the yoke portion 11. The tooth portions 12 are spaced apart from each other in the circumferential direction. The tooth portions 12 protrude radially inward from the inner circumferential face of the yoke portion 11. Each tooth portion 12 has a wall shape extending in the radial and axial directions. Each tooth portion 12 has a tooth body 13 having a wall shape extending in the radial and axial directions, and tooth protruding portions 14 protruding from a leading end (i.e., an end on the inner side in the radial direction) of the tooth body 13 to the two sides in the circumferential direction.

The stator core 10 may be, for example, a laminated steel sheet produced by stacking a plurality of electromagnetic steel sheets (e.g., silicon steel sheets) in the thickness direction, or a dust core made by pressing magnetic particles with insulating coating.

The stator core 10 has a plurality of slots 15 as shown in FIG. 1. The slots 15 are arranged in a ring shape. The slots 15 extend in the axial direction through the stator core 10. Each slot 15 has a first opening 16, a second opening 17, and a third opening 18, as shown in FIGS. 1 and 8. The first opening 16 is formed in a face of the stator core 10 on a first side in the axial direction. The second opening 17 is formed in a face of the stator core 10 on a second side in the axial direction. The third opening 18 is formed in a face of the stator core 10 on the inner side in the radial direction. The third opening 18 is continuous with the first opening 16 and the second opening 17. Each slot 15 is constituted by two adjacent tooth portions 12, as shown in FIG. 2. Each slot 15 is demarcated on the two sides in the circumferential direction by the tooth portions 12, and has an outer circumferential face in the radial direction that is demarcated by the yoke portion 11.

The coil 20 may be of distributed or concentrated winding. The coil 20 is wound around the teeth portions 12 through the slots 15. As shown in FIG. 2, the coil 20 has a rectangular cross section taken in a direction orthogonal to the lengthwise direction. The coil 20 includes a core wire forming a conductive path, and a covering portion that covers the core wire. The core wire is made of a conductor. The core wire is a flat wire and has a rectangular cross section taken in a direction orthogonal to the lengthwise direction. The covering portion forms an insulating layer. There is no specific limitation to the material of the covering portion. The covering portion in this embodiment is made of enamel with a low dielectric constant. The main component of the covering portion may be a thermosetting resin such as polyvinylformal, thermosetting polyurethane, thermosetting acrylic, epoxy, thermosetting polyester, thermosetting polyesterimide, aromatic polyamide, thermosetting polyamideimide, or thermosetting polyimide. Alternatively, the main component of covering portion may be a thermoplastic resin such as polyetherimide, polyphenylene ether, polyethersulfone, polyphenylene sulfide, polyetheretherketone, or thermoplastic polyimide. Here, the “main component” refers to a component with the highest content, e.g., 50% or more by mass.

The coil 20 has a first coil portion 21 and a second coil portion 22, as shown in FIG. 8. The first coil portion 21 and the second coil portion 22 each have a straight shape. A first end of the first coil portion 21 and a first end of the second coil portion 22 are press-fitted and joined to each other. The first coil portion 21 and the second coil portion, which are press-fitted into each other, form a straight shape as a whole. A recessed portion 23 is provided at the first end (i.e., an end on the first side in the axial direction) of the first coil portion 21. A projecting portion 24 is provided at the first end (i.e., an end on the second side in the axial direction) of the second coil portion 22. The first coil portion 21 and the second coil portion 22 are press-fitted into each other by press-fitting the projecting portion 24 into the recessed portion 23.

As shown in FIG. 8, at least a part of the first coil portion 21 is located within the slot 15. It is preferable that the first end side (the end on the first end in the axial direction) of the first coil portion 21 is located within the slot 15. That is, it is preferable that the first end of the first coil portion 21 is located at the same position in the axial direction as an opening edge of the first opening 16, or on the second side in the axial direction relative to the opening edge of the first opening 16. In the example shown in FIG. 8, the first end of the first coil portion 21 is located at the same position in the axial direction as the opening edge of the first opening 16.

The recessed portion 23 of the first coil portion 21 is formed by recessing a part of an end face 21A on the first side in the axial direction of the first coil portion 21. The recessed portion 23 is open to the first side in the axial direction of the first coil portion 21. The recessed portion 23 is provided in a central part of the first coil portion 21 with respect to the circumferential direction and open to the two sides of the first coil portion 21 in the axial direction. The recessed portion 23 has two opposing inner faces 23A provided on the respective sides in the circumferential direction, and a distal face 23B. The two inner faces 23A and the distal face 23B are flat faces. The distal face 23B faces the first side in the axial direction. The distal face 23B is continuous with the ends of the two inner faces 23A on the second side in the axial direction, and connects the ends of the two inner faces 23A on the second side in the axial direction to each other.

As shown in FIG. 8, at least a part of the second coil portion 22 is located within the slot 15. The first end side (the end on the second side in the axial direction) of the second coil portion 22 is located within the slot 15.

The projecting portion 24 of the second coil portion 22 protrudes from a base face 22A of the second coil portion 22 on the second side in the axial direction. The projecting portion 24 protrudes to the second side in the axial direction. The base face 22A is a flat faces facing the second side in the axial direction. The projecting portion 24 is provided in a central part of the second coil portion 22 with respect to the circumferential direction, and protrudes to the first side in the axial direction from the base face 22A on the two sides in the circumferential direction. The projecting portion 24 extends over the entire region of the second coil portion 22 in the radial direction. The projecting portion 24 has a rectangular cross section taken in a direction orthogonal to the axial direction. The projecting portion 24 has outer circumferential faces including a pair of first outer faces 24A, a pair of second outer faces 24B, and a protruding end face 24C. The two first outer faces 24A face the circumferential direction. The two second outer faces 24B face the radial direction. The protruding end face 24C faces the first side in the axial direction. The protruding end face 24C is continuous with the ends on the first side of the two first outer faces 24A and the two second outer faces 24B, and connects the ends on the first side of the two first outer faces 24A and the two second outer faces 24B to each other.

With the projecting portion 24 press-fitted into the recessed portion 23, the protruding end face 24C of the projecting portion 24 faces the distal face 23B of the recessed portion 23. The two first outer faces 24A of the projecting portion 24 face the two respective inner circumferential faces 23A of the recessed portion 23. The end face 21A of the first coil portion 21 on the first side in the axial direction faces the base face 22A the second coil portion 22. A gap G is formed between the first end of the first coil portion 21 and the first end of the second coil portion 22 (i.e., between the end face 21A and the base face 22A).

The coil 20 has a first extension portion 26 extending from a second end of the first coil portion 21 via a first bent portion 25, and a second extension portion 28 extending from a second end of the second coil portion 22 via a second bent portion 27.

The insulating resin 30 fills the slots 15. FIG. 2 shows slots 15A and 15B as the slots 15. The insulating resin 30 in the slot 15A is omitted in FIG. 2. The slot 15B is filled with the insulating resin 30 in FIG. 2. The insulating resin 30 has a continuous filling portion 31 that continuously fills the space between the inner walls of the slot 15B (slot 15) and the first coil portion 21 in a central part of the stator core 10 in the axial direction. The continuous filling portion 31 continuously fills the slot 15B (slot 15) in the axial direction except at its two ends. With this configuration, insulating paper is not interposed between the inner walls of the slot 15 and the first coil portion 21 in the continuous filling portion 31. This allows heat of the coil 20 to be easily dissipated.

As mentioned above, the first coil portion 21 has the recessed portion 23. The second coil portion 22 has the projecting portion 24, which is press-fitted into the recessed portion 23. The fitting faces of the recessed portion 23 and the projecting portion 24 are likely to generate heat when a current flows. However, this configuration allows heat generated in these fitting faces to be easily dissipated from the insulating resin 30 due to the fitting faces of the recessed portion 23 and the projecting portion 24 (more specifically, the pair of inner faces 23A of the recessed portion 23, the distal face 23B of the recessed portion 23, the pair of first outer faces 24A of the projecting portion 24, and the protruding end face 24C of the projecting portion) are located at positions relatively close to the insulating resin 30, compared to a configuration in which the second coil portion 22 has the recessed portion 23 and the first coil portion 21 has the projecting portion 24.

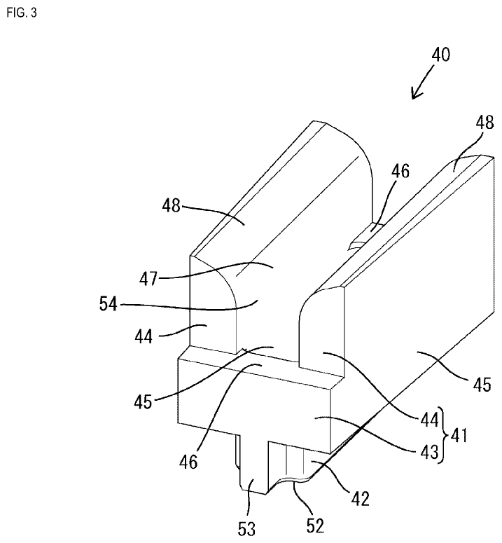

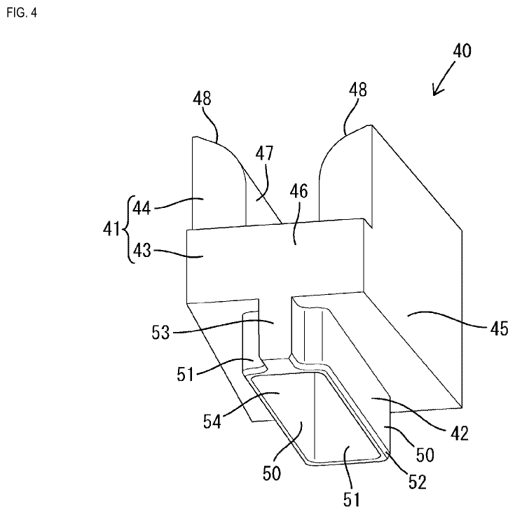

The first positioning component 40 corresponds to an example of a “positioning component” and an example of a “jig”. The first positioning component 40 has insulating properties and is made of a material such as resin or ceramic. The first positioning component 40 has a rectangular ring shape, as shown in FIGS. 3 and 4. The first positioning component 40 has a base 41 and a protrusion 42.

The base 41 has a rectangular ring-shaped base portion 43 and protruding portions 44. The rectangular ring-shaped base portion 43 has a rectangular ring shape. The rectangular ring-shaped base portion 43 has a pair of lengthwise portions 45 and a pair of widthwise portions 46. The two lengthwise portions 45 extend straight and parallel to each other. The two lengthwise portions 45 extend in the radial direction. The widthwise portions 46 are shorter than the lengthwise portions 45. The two widthwise portions 46 extend straight and parallel to each other. The two widthwise portions 46 extend in a direction orthogonal to the lengthwise portions 45. The two widthwise portions 46 extend in the circumferential direction. The pair of lengthwise portions 45 and the pair of widthwise portions 46 form a rectangular ring shape as a whole.

The protruding portions 44 protrude from the base 41 to the first side in the axial direction. The protruding portions 44 protrude from the two lengthwise portions 45 to the first side in the axial direction. That is, a pair of protruding portions 44 are provided. Each of the two protruding portions 44 has an inclined face 48, and an opposing face 47 that faces the opposing face 47 of the other extension 44. The two opposing faces 47 face each other in the circumferential direction. The opposing faces 47 are faces expanding in the axial direction and the radial direction. At least a part of each opposing face 47 is flush with an inner circumferential face of the rectangular ring-shaped base portion 43 (more specifically, a corresponding one of the faces of the two lengthwise portions 45 that face each other). The two inclined faces 48 are inclined so as to be separated farther from each other while extending to the protruding side of the protruding portions 44 (i.e., the first side in the axial direction). The ends of the two protruding portions 44 on the inner side in the radial direction are located radially inward of the inner circumferential face of the rectangular ring-shaped base portion 43 and radially inward of the inner circumferential face of the protrusion 42. The ends of the two protruding portions 44 on the outer side in the radial direction are located radially outward of the inner circumferential face of the rectangular ring-shaped base portion 43 and radially outward of the inner circumferential face of the protrusion 42. The ends of the two opposing faces 47 and the two inclined faces 48 on the inner side in the radial direction are located radially inward of the inner circumferential face of the rectangular ring-shaped base portion 43 and radially inward of the inner circumferential face of the protrusion 42. The ends of the two opposing faces 47 and the two inclined faces 48 on the outer side in the radial direction are located radially outward of the inner circumferential face of the rectangular ring-shaped base portion 43 and radially outward of the inner circumferential face of the protrusion 42.

The protrusion 42 protrudes in a tubular shape from the base 41 to the side opposite to the protruding portions 44 (i.e., the second side in the axial direction). The protrusion 42 protrudes in a tubular shape from the inner circumferential portion of the tubular base 41. The protrusion 42 has a rectangular-tubular shape. The protrusion 42 has a pair of lengthwise plate portions 50 and a pair of widthwise plate portions 51. The two lengthwise plate portions 50 extend straight and parallel to each other. The two lengthwise plate portions 50 extend in the radial direction. The widthwise plate portions 51 are shorter than the lengthwise plate portions 50. The two widthwise plate portions 51 extend straight and parallel to each other. The two widthwise plate portions 51 extend in a direction orthogonal to the lengthwise plate portions 50. The two widthwise plate portions 51 extend in the circumferential direction. The pair of lengthwise plate portions 50 and the pair of widthwise plate portions 51 form a rectangular ring shape (more specifically, a rectangular-tubular shape) as a whole.

The inner circumferential face of the protrusion 42 is seamlessly continuous with the inner circumferential face of the base 41 (rectangular ring-shaped base portion 43). The outer circumferential face of the protrusion 42 has an outer circumferential tapered face 52 that tapers toward the protruding end.

The first positioning component 40 has an inner protrusion 53 that protrudes radially inward from the outer circumferential face of the protrusion 42. The inner protrusion 53 is located in a gap between the tooth protruding portions 14 in the circumferential direction, as shown in FIG. 2.

The first positioning component 40 has a pair of positioning faces 54, as shown in FIGS. 3 and 4. The pair of positioning faces 54 positions the first coil portion 21 and the second coil portion 22 with respect to the circumferential direction. The pair of positioning faces 54 is constituted by the pair of opposing faces 47, the inner circumferential face of the rectangular ring-shaped base portion 43 (more specifically, the faces of the pair of lengthwise portions 45 that face each other), and the inner circumferential face of the protrusion 42 (more specifically, the faces of the pair of lengthwise plate portions 50 that face each other).

The second positioning component 60 in the present embodiment has the same form as the first positioning component 40, and its detailed description is omitted accordingly.

The first positioning component 40 positions the first coil portion 21 on the first side in the axial direction relative to the continuous filling portion 31, with the protrusion 42 sandwiched between the inner walls of the slot 15 and the first coil portion 21, as shown in FIG. 8. In the circumferential direction, the first coil portion 21 is positioned by the protrusion 42 sandwiched between the first coil portions 21 and the inner walls of the slot 15 on both sides of one first coil portion 21. In the radial direction, the first coil portion 21 is positioned by the protrusion 42 sandwiched between an innermost first coil portion 21, out of a plurality of first coil portions 21 arranged in the radial direction, and the inner walls of the slot 15, as well as between an outermost first coil portion 21 and the inner walls of the slot 15. With this configuration, the first coil portion 21 is positioned with the protrusion 42 of the first positioning component 40 sandwiched between the inner walls of the slot 15 and the first coil portion 21. The position of the first coil portion 21 within the slot 15 is thus likely to be stable, and consequently, the heat dissipation performance of the first coil portions 21 via the insulating resin 30 is likely to be stable.

The first positioning component 40 positions both the first coil portion 21 and the second coil portion 22. With this configuration, both the first coil portion 21 and the second coil portion 22 are positioned by the first positioning component 40, thus making the fitting therebetween unlikely to loosen.

The first positioning component 40 is located inside and outside the slot 15 in the axial direction, and positions the first coil portion 21 and the second coil portion 22 inside and outside the slot 15. More specifically, the inner circumferential face of the protrusion 42 of the first positioning component 40 positions the first coil portion 21 inside the slot 15, and the inner circumferential face of the rectangular ring-shaped base portion 43 and the pair of opposing faces 47 of the pair of protruding portions 44 position the second coil portion 22 outside the slot 15. With this configuration, the first coil portion 21 and the second coil portion 22 are positioned inside and outside the slot 15, and the positions of the first coil portion 21 and the second coil portion 22 are thus more likely to be stable.

As shown in FIG. 8, the first positioning component 40 covers the gap G between the first coil portion 21 and the second coil portion 22, which are press-fitted into each other, in the circumferential direction. This makes foreign objects unlikely to enter the gap G between the first coil portion 21 and the second coil portion 22.

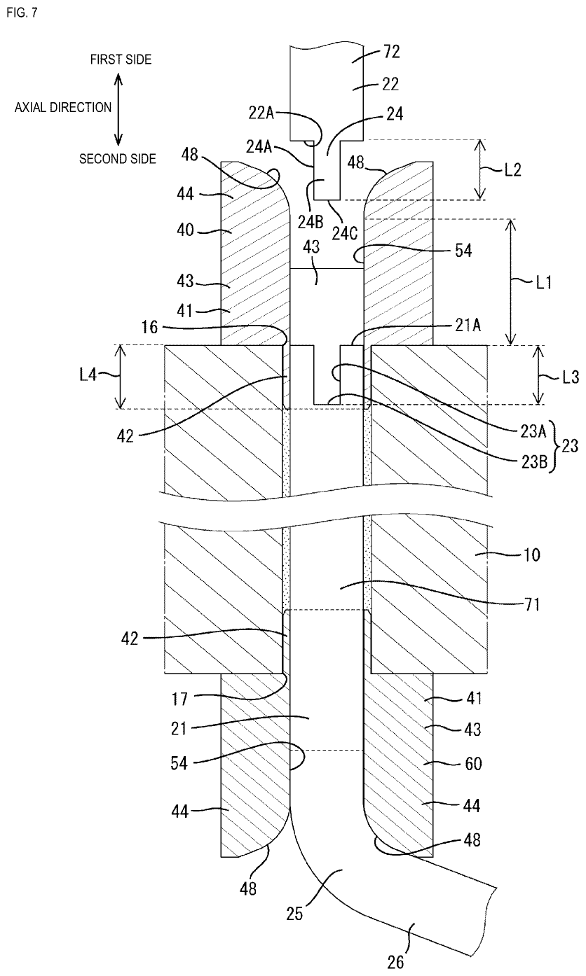

A length L1 in the axial direction of a region where the first positioning component 40 positions the second coil portion 22 is greater than a protruding dimension L2 of the projecting portion 24 and than a depth L3 of the recessed portion 23, as shown in FIG. 7. This configuration allows the second coil portion 22 to be positioned more accurately. Note that the length L1 in the axial direction of the region where the first positioning component 40 positions the second coil portion 22 is the length from the end of the base 41 on the second side in the axial direction to the ends of the opposing faces 47 on the first side in the axial direction. The protruding dimension L2 of the projecting portion 24 is the length from the base face 22A to the protruding end face 24C. The depth L3 of the recessed portion 23 is the length from the end face 21A of the first coil portion 21 on the first side in the axial direction to the distal face 23B of the recessed portion 23. The depth L3 of the recessed portion 23 is smaller than the protruding dimension L4 of the protrusion 42.

Similarly to the first positioning component 40, the second positioning component 60 positions the first coil portion 21 on the second side in the axial direction relative to the continuous filling portion 31, with the protrusion 42 sandwiched between the inner walls of the slot 15 and the first coil portion 21, as shown in FIG. 8.

The first coil portion 21 is positioned by the first positioning component 40 and the second positioning component 60, as shown in FIG. 8. With this configuration, the first coil portion 21 is positioned on both sides in the axial direction, and the position of the first coil portion 21 is thus more likely to be stable.

The inclined faces 48 of the first positioning component 40 extend along the first extension portion 26 of the coil 20, as shown in FIG. 8. The inclined faces 48 of the second positioning component 60 extend along the second extension portion 28 of the coil 20. With this configuration, the inclined faces 48 of the first positioning component 40 restrict displacement of the first extension portion 26, and the inclined faces 48 of the second positioning component 60 restrict displacement of the second extension portion 28, thus making the orientation of the coil 20 more stable.

As shown in FIG. 2, a plurality of (four in the present embodiment) first coil portions 21 are arranged within one slot 15. The plurality of first coil portions 21 are arranged in a row in the radial direction within one slot 15.

### Method for Producing Stator 1

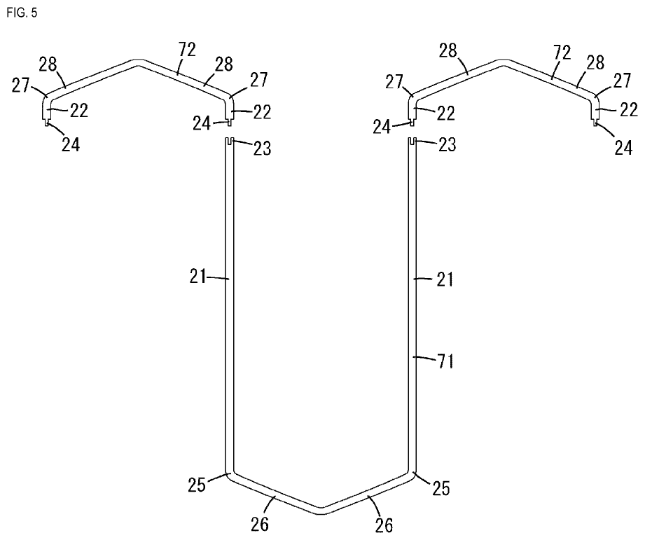

The stator 1 has a first coil segment 71 and a second coil segment 72 shown in FIG. 5 as components of the coil 20.

The first coil segment 71 has a pair of first coil portions 21 and a pair of first extension portions 26. The first coil portions 21 are located at the respective ends of the first coil segment 71. A first end of each first extension portion 26 is continuous with a second end of a corresponding one of the two first coil portions 21 via the first bent portion 25. Second ends of the first extension portions 26 are continuous with each other. That is, the second ends of the two first coil portions 21 are continuous with each other via the first extension portions 26.

The second coil segment 72 has a pair of second coil portions 22 and a pair of second extension portions 28. The second coil portions 22 are located at the respective ends of the second coil segment 72. A first end of each second extension portion 28 is continuous with a second end of a corresponding one of the two second coil portions 22 via the second bent portion 27. Second ends of the second extension portions 28 are continuous with each other. That is, the second ends of the two second coil portions 22 are continuous with each other via the second extension portions 28.

The method of producing the stator 1 includes an attaching step, a first positioning step, a second positioning step, a filling step, and a press-fitting step.

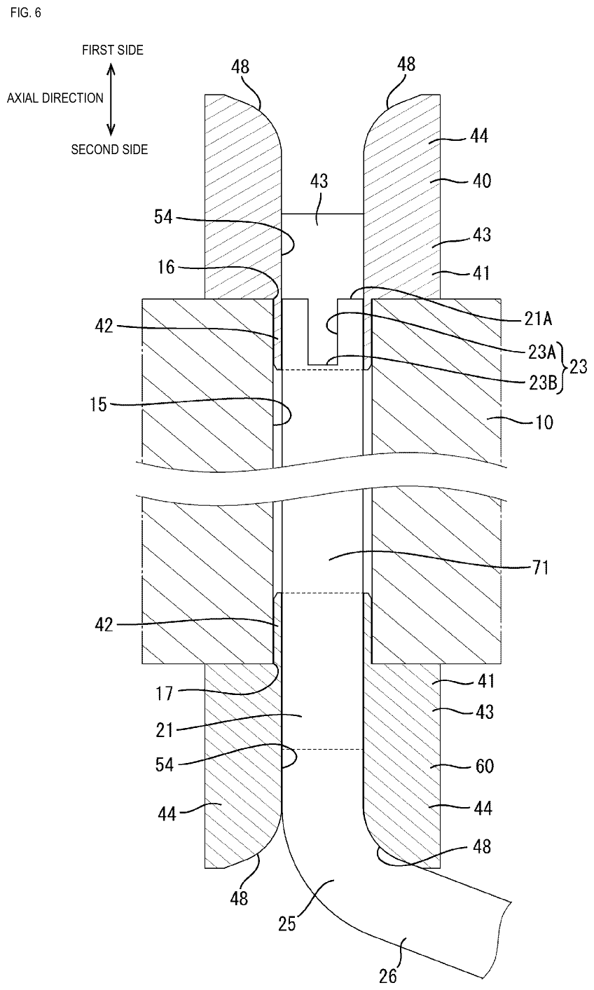

In the attaching step, the second positioning component 60 is attached to each first coil portion 21 of the first coil segment 71 (see FIG. 6). The first end side with the recessed portion 23 of the first coil portion 21 is inserted between the two inclined faces 48 of the second positioning component 60, and is then inserted between the two positioning faces 54. The first coil portion 21 is inserted between the two positioning faces 54 while being guided into the space between the two positioning faces 54 by the pair of inclined faces 48, even if the first coil portion 21 slightly shifts in the circumferential direction. Thus, this configuration allows the first coil portion 21 to be easily passed between the two positioning faces 54.

In the first positioning step, the second positioning component 60 attached to the first coil portion 21 is disposed on the second side in the axial direction of the slot 15, and positions the first coil portion 21 (see FIG. 6). The second positioning component 60 is disposed so as to cover at least a part of the opening edge of the slot 15 on the second side in the axial direction. The protruding end side of the protrusion 42 of the second positioning component 60 is inserted into the slot 15. The protrusion 42 has the outer circumferential tapered face 52 on the protruding end side. This guides the protrusion 42 into the slot 15 even if the protrusion 42 slightly shifts while being inserting into the slot 15. Thus, this configuration allows the protrusion 42 of the second positioning component 60 to be easily inserted into the slot 15. The base 41 of the second positioning component 60 is disposed at the end of the stator core 10 on the second side in the axial direction. The second positioning component 60 is disposed so as to block the opening (second opening 17) of the slot 15 on the second side in the axial direction.

The second positioning step corresponds to an example of a “positioning step”. In the second positioning step, the first positioning component 40 is disposed on the first side in the axial direction of the slot 15, and the first coil portion 21 is positioned by the first positioning component 40 and the second positioning component 60 (see FIG. 6). The first positioning component 40 is disposed so as to cover at least a part of the opening edge of the slot 15 on the first side in the axial direction. The protruding end side of the protrusion 42 of the first positioning component 40 is inserted into the slot 15. The protrusion 42 has the outer circumferential tapered face 52 on the protruding end side. This guides the protrusion 42 into the slot 15 even if the protrusion 42 slightly shifts while being inserted into the slot 15. Thus, this configuration makes it easy to insert the protrusion 42 of the first positioning component 40 into the slot 15. The protrusion 42 is inserted into the gap between the inner walls of the slot 15 and the first coil portion 21, and is sandwiched between the inner walls of the slot 15 and the first coil portion 21. The base 41 of the first positioning component 40 is disposed at the end of the stator core 10 on the first side in the axial direction. The first positioning component 40 is disposed so as to block the opening (first opening 16) of the slot 15 on the first side in the axial direction.

In the filling step, the space between the inner walls of the slot 15 and the first coil portion 21 of the first coil segment 71 is continuously filled with the insulating resin 30 in a central part of the slot 15 in the axial direction (see FIG. 7). The insulating resin 30 continuously filling the space between the inner walls of the slot 15 and the first coil portion 21 of the first coil segment 71 allows the heat of the first coil portion 21 to be easily dissipated through the insulating resin 30, thereby improving the heat dissipation of the coil 20. When filling the space with the insulating resin 30, the first positioning component 40 blocks the opening (first opening 16) of the slot 15 on the first side in the axial direction. The second positioning component 60 blocks the opening (second opening 17) of the slot 15 on the second side in the axial direction. A separate member blocks the opening (third opening 18) of the slot 15 on the inner side in the radial direction except for a resin-injecting section. The insulating resin 30 is charged into the slot 15 from the third opening 18. This configuration allows the first positioning component 40 and the second positioning component 60 to easily prevent the insulating resin 30 from leaking out from the two sides in the axial direction of the slot 15. The filling step is performed with the first coil portion 21 of the first coil segment 71 positioned by the first positioning component 40 and the second positioning component 60. This configuration allows the first coil segment 71 to be easily disposed at an appropriate position when the insulating resin 30 solidifies. Further, the solidified insulating resin 30 fixes the first coil portion 21 within the slot 15.

In the press-fitting step, the second coil segment 72 is press-fitted into the first coil segment 71 (see FIG. 8). The recessed portion 23 of the first coil portion 21 and the projecting portion 24 of the second coil portion 22 are press-fitted into each other in a range where the first positioning component 40 is present in the axial direction. This configuration prevents the relative positions of the recessed portion 23 and the projecting portion 24 from shifting easily. Consequently, a situation in which the projecting portion 24 is not appropriately press-fitted into the recessed portion 23 is likely to be avoided. Additionally, the pair of inclined faces 48 of the first positioning component 40 is located on the first side in the axial direction relative to the pair of positioning faces 54. With this configuration, the second coil segment 72 is inserted between the two positioning faces 54 while being guided by the inclined faces 48 into the space between the two positioning faces 54, even if the position of the second coil segment 72 slightly shifts. Thus, this configuration allows the second coil portion 22 of the second coil segment 72 to be easily passed between the two positioning faces 54 from the first side in the axial direction. In the above second positioning step, the first coil segment 71 is positioned such that the length L1 in the axial direction of the region where the second coil segment 72 is positioned in the pair of the positioning faces 54 of the first positioning component 40 is greater than the protruding dimension L2 of the projecting portion 24. With this configuration, the second coil segment 72 can be press-fitted into the first coil segment 71 while being guided into the space between the two positioning faces 54. Thus, this configuration allows the second coil segment 72 to be easily press-fitted into the first coil segment 71. The stator 1 is produced through those steps.

### Second Embodiment

In the second embodiment, a first other form of the first positioning component is described. The same configurations as the first embodiment are assigned the same reference signs, and detailed description thereof is omitted.

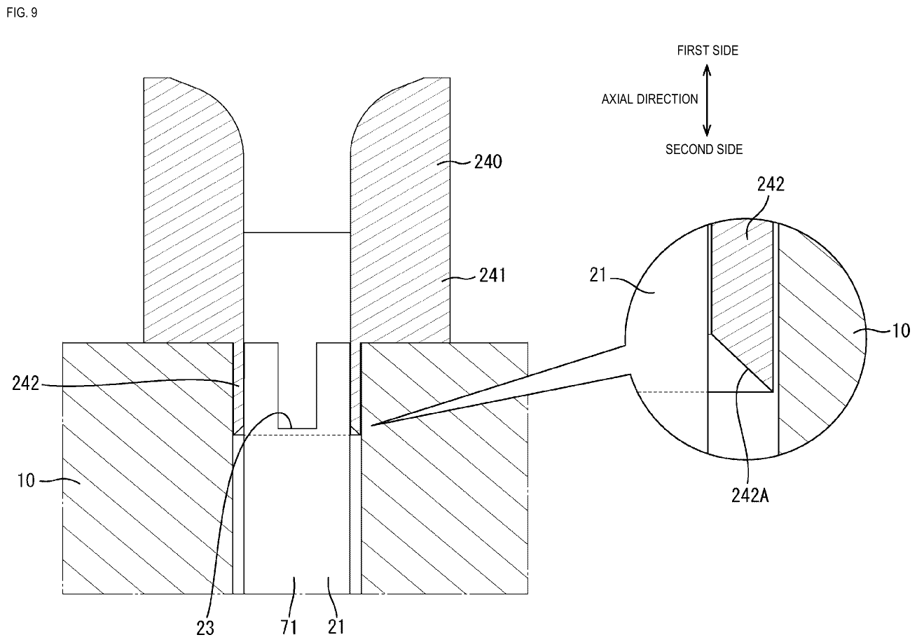

A first positioning component 240 of the second embodiment corresponds to an example of a “jig”. The first positioning component 240 has insulating properties and is made of a material such as resin or ceramic. The first positioning component 240 has a rectangular ring shape. As shown in FIG. 9, the first positioning component 240 has a base 241 located at an end of the stator core 10 on the first side, and a protrusion 242 protruding in a tubular shape from the base 241. The base 241 has the same form as the base 41 of the first embodiment.

The protrusion 242 protrudes in a tubular shape from the base 241 to the opposite side to the protruding portions 44 (i.e., the second side in the axial direction). The protrusion 242 protrudes in a tubular shape from the inner circumferential portion of the tubular base 241. The protrusion 242 has a rectangular-tubular shape.

The inner circumferential face of the protrusion 242 is seamlessly continuous with the inner circumferential face of the base 241 (rectangular ring-shaped base portion 43). The inner circumferential face of the protrusion 242 includes an inner circumferential tapered face 242A that tapers such that the hole in the protrusion 242 expands toward the protruding end.

The first positioning component 240 differs from the first positioning component 40 of the first embodiment in that the first positioning component 240 has the inner circumferential tapered face 242A and does not have the outer circumferential tapered face 52, but is otherwise the same.

Similar to the method for producing the stator 1 according to the first embodiment, the method for producing the stator according to the second embodiment includes an attaching step, a first positioning step, a second positioning step, a filling step, and a press-fitting step.

That is, in the second positioning step, the protrusion 242 of the first positioning component 240 is inserted into the gap between the inner walls of the slot 15 and the first coil portion 21, and sandwiched between the inner walls of the slot 15 and the first coil portion 21.

With this configuration, the inner circumferential face of the protrusion 242 has the inner circumferential tapered face 242A, which guides the first coil portion 21 of the first coil segment 71 into the protrusion 242 when the first coil portion 21 is passed into the protrusion 242, even if the first positioning component 240 slightly shifts. Thus, this configuration allows the first coil portion 21 to be easily passed into the protrusion 242.

### Third Embodiment

In the third embodiment, a second other form of the first positioning component is described. The first positioning component of the third embodiment differs from the first positioning component of the second embodiment in that the first positioning component has not only the inner circumferential tapered face but also the outer circumferential tapered face, but is otherwise the same. The same configurations as the first embodiment are assigned the same reference signs, and a detailed description thereof is omitted.

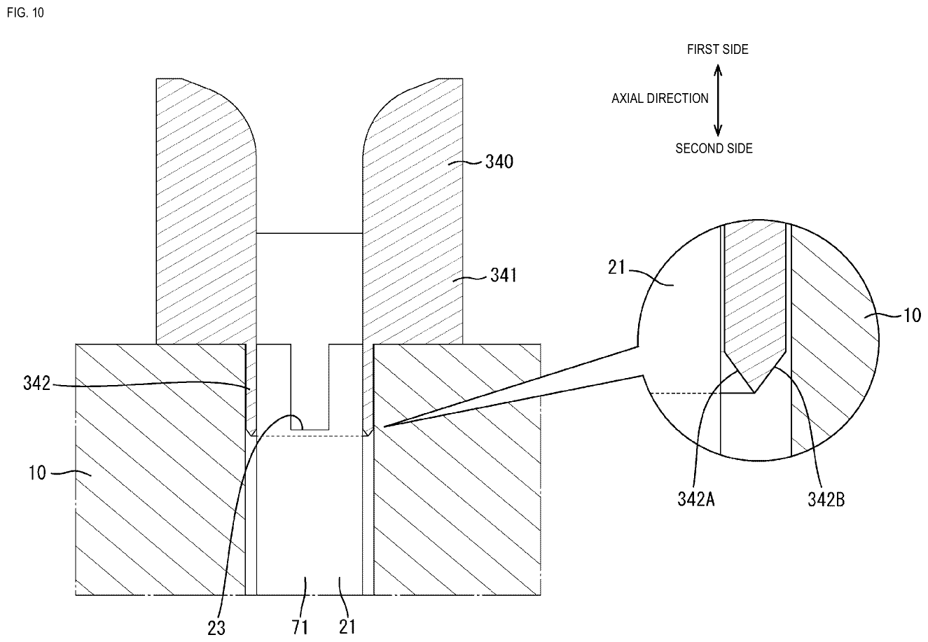

A first positioning component 340 of the third embodiment corresponds to an example of a “jig”. The first positioning component 340 has insulating properties and is made of a material such as resin or ceramic. The first positioning component 340 has a rectangular ring shape. As shown in FIG. 10, the first positioning component 340 has a base 341 located at an end of the stator core 10 on the second side, and a protrusion 342 protruding in a tubular shape from the base 341. The base 341 has the same form as the base 41 of the first embodiment.

The protrusion 342 protrudes in a tubular shape from the base 341 to the opposite side to the extensions 44 (i.e., the second side in the axial direction). The protrusion 342 protrudes in a tubular shape from the inner circumferential portion of the tubular base 341. The protrusion 342 has a rectangular-tubular shape.

The inner circumferential face of the protrusion 342 is seamlessly continuous with the inner circumferential face of the base 341 (rectangular ring-shaped base portion 43). The inner circumferential face of the protrusion 342 includes an inner circumferential tapered face 342A that tapers such that the hole in the protrusion 342 expands toward the protruding end.

The outer circumferential face of the protrusion 342 includes an outer circumferential tapered face 342B that tapers toward the protruding end.

The first positioning component 340 differs from the first positioning component 40 of the first embodiment in that the first positioning component 340 has the inner circumferential tapered face 342A and the outer circumferential tapered face 342B and does not have the outer circumferential tapered portion 52, but is otherwise the same.

Similar to the method for producing the stator 1 according to the first embodiment, the method for producing the stator according to the third embodiment includes an attaching step, a first positioning step, a second positioning step, a filling step, and a press-fitting step.

That is, in the second positioning step, the protrusion 342 of the first positioning component 340 is inserted into the gap between the inner walls of the slot 15 and the first coil portion 21, and is sandwiched between the inner walls of the slot 15 and the first coil portion 21.

With this configuration, the inner circumferential tapered face 342A and the outer circumferential tapered face 342B are formed on the protruding end side of the protrusion 342, and the protrusion 342 is thus guided into the space between the inner walls of the slot 15 and the first coil portion 21 even if the protrusion 342 slightly shifts. Thus, this configuration allows the protrusion 342 of the first positioning component 340 to be easily inserted into the gap between the inner walls of the slot 15 and the first coil portion 21.

### Other Embodiments

The present disclosure is not limited to the embodiments described above and illustrated in the drawings. For example, the features of the above or following embodiments can be combined in any way as long as no contradiction arises. Further, any of the features of the above embodiments may also be omitted unless explicitly stated as essential.

In the above embodiments, the first positioning component, which is a component of the stator, is used as a first jig, and the second positioning component is used as a second jig. However, the stator may alternatively be produced using a jig that is not a component of the stator.

In the second embodiment, the second positioning component may have the same form as the first positioning component.

In the third embodiment, the second positioning component may have the same form as the first positioning component.

Note that the embodiments disclosed herein is in all respects illustrative and should not be considered restrictive. The scope of the present disclosure is not limited by the embodiments disclosed herein, and is intended to encompass all the changes made within the scope of the claims or the scope equivalent to the claims.

1. A stator comprising:
a stator core having a ring shape;
a coil;
insulating resin; and
a positioning component,
wherein the stator core has a plurality of slots arranged in a ring shape and extending through the stator core in an axial direction,
the coil has:
a first coil portion that is at least partially located within the slots; and
a second coil portion having a first end press-fitted into a first end of the first coil portion,
the insulating resin has a continuous filling portion continuously filling a space between an inner wall of the slots and the first coil portion in a central part of the slots with respect to the axial direction,
the positioning component is located on a first side in the axial direction relative to the continuous filling portion, and positions the first coil portion while being at least partially sandwiched between the inner wall of the slots and the first coil portion in a circumferential direction of the stator core, and
the positioning component covers a gap between the first coil portion and the second coil portion that are press-fitted into each other, in the circumferential direction.

2. The stator according to claim 1,
wherein the positioning component positions both the first coil portion and the second coil portion.

3. The stator according to claim 2,
wherein the positioning component positions the first coil portion and the second coil portion inside and outside the slots in the axial direction.

4. The stator according to claim 1,
wherein a recessed portion is provided at one of the first end of the first coil portion and the first end of the second coil portion, and a protruding portion is provided at another one of the first end of the first coil portion and the first end of the second coil portion, and
the protruding portion is press-fitted into the recessed portion.

5. The stator according to claim 4,
wherein the recessed portion is provided in the first coil portion, and
the protruding portion is provided in the second coil portion.

6. The stator according to claim 5,
wherein the positioning component positions both the first coil portion and the second coil portion, and
a length in the axial direction of a region where the positioning component positions the second coil portion is greater than a protruding dimension of the protruding portion and than a depth of the recessed portion.

7. A method for producing a stator including a ring-shaped stator core and a coil, the stator core having a plurality of slots arranged in a ring shape and extending through the stator core in an axial direction, the coil having a first coil segment and second coil segment,
the method comprising:
a disposing step of disposing a jig on a first side in the axial direction of the slots;
a positioning step of positioning the first coil segment using the jig;
a press-fitting step of press-fitting a first end of the second coil segment into a first end of the first coil segment positioned in the positioning step; and
a filling step of continuously filling a space between an inner wall of the slots and the first coil segment with insulating resin in a central part of the slots with respect to the axial direction,
wherein in the press-fitting step, the first end of the second coil segment is press-fitted into the first end of the first coil segment with the first end of the first coil segment located in a range where the jig is present in the axial direction.

8. The method for producing a stator according to claim 7,
wherein the jig has a pair of positioning faces that position the first coil segment and the second coil segment, and a pair of inclined faces that guide the second coil segment into a space between the two positioning faces, and
in the disposing step, the jig is disposed such that the pair of inclined faces is located on the first side in the axial direction relative to the pair of positioning faces.

9. The method for producing a stator according to claim 7,
wherein a recessed portion is provided at one of the first end of the first coil portion and the first end of the second coil portion, and a protruding portion is provided at another one of the first end of the first coil portion and the first end of the second coil portion,
the protruding portion is press-fitted into the recessed portion,
the jig has a pair of positioning faces that positions the first coil segment and the second coil segment, and
in the positioning step, the first coil segment is positioned such that a length in the axial direction of a region where the second coil segment is positioned in the pair of positioning faces is greater than a protruding dimension of the protruding portion.

10. The method for producing a stator according to claim 9,
wherein in the filling step, the slots are filled with the insulating resin while blocking an opening of the slots on the first side in the axial direction using the jig.

11. The stator according to claim 2,
wherein a recessed portion is provided at one of the first end of the first coil portion and the first end of the second coil portion, and a protruding portion is provided at another one of the first end of the first coil portion and the first end of the second coil portion, and
the protruding portion is press-fitted into the recessed portion.

12. The stator according to claim 3,
wherein a recessed portion is provided at one of the first end of the first coil portion and the first end of the second coil portion, and a protruding portion is provided at another one of the first end of the first coil portion and the first end of the second coil portion, and
the protruding portion is press-fitted into the recessed portion.

13. The method for producing a stator according to claim 8,
wherein a recessed portion is provided at one of the first end of the first coil portion and the first end of the second coil portion, and a protruding portion is provided at another one of the first end of the first coil portion and the first end of the second coil portion,
the protruding portion is press-fitted into the recessed portion,
the jig has a pair of positioning faces that positions the first coil segment and the second coil segment, and
in the positioning step, the first coil segment is positioned such that a length in the axial direction of a region where the second coil segment is positioned in the pair of positioning faces is greater than a protruding dimension of the protruding portion.
